(19) United States
(12) Patent Application Publication
(10) Pub. No.: US 2007/0088657 A1
(43) Pub. Date: Apr. 19, 2007

(54) Information tracking system and method involving charitable giving

(76) Inventor: Roger S. Greene, Coto de Caza, CA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/497,812

(22) Filed: Aug. 2, 2006

Related U.S. Application Data
(60) Provisional application No. 60/704,935, filed on Aug. 2, 2005.

(51) Int. Cl. G06Q 40/00

(52) U.S. Cl. 705/39

(57) ABSTRACT

The present invention relates to information tracking systems involving charitable giving. More particularly, this invention relates to a system and method for tracking charitable giving in conjunction with and without the issuance of a credit or charge card. Further, the invention associates charitable donations with business transactions, and more particularly, the invention associates a charitable donation with a tax deductible transaction. In addition, the present invention uniquely enables the donor to select the recipient of the charitable donation.

### CROSS-REFERENCE TO RELATED APPLICATIONS

This patent application claims the benefit of U.S. Provisional Patent Application No. 60/704,935, filed Aug. 2, 2005, which is incorporated herein by reference in its entirety.

### FIELD OF THE INVENTION

The present invention relates to information tracking systems involving charitable giving. More particularly, this invention relates to a system and method for tracking charitable giving in conjunction with and without the issuance of a credit or charge card. Further, the invention associates charitable donations with business transactions, and more particularly, the invention associates a charitable donation with a tax deductible transaction. In addition, the present invention uniquely enables the donor to select the recipient of the charitable donation.

### BACKGROUND OF THE INVENTION

Charitable organizations typically struggle with efficient fundraising. Every dollar spent to raise money for the charity cannot be used to advance the mission or cause of the charity. Due to the need to keep overhead expenses to a minimum, many charitable organizations have been unable to take advantage of newer technologies for the purposes of fundraising because to do so would require an investment in information technology and its infrastructure. As a result, charitable organizations typically employ traditional methods of fundraising, relying on corporate sponsors for a large part of their capital. A related phenomenon is that individuals generally desire to contribute to charitable causes and organizations, often citing the lack of ease of doing so as a main impediment to making more contributions.

Banks and other lending institutions issuing credit cards currently concentrate on affinity relationships. Some of the affinity relationships involve charitable organizations, schools or foundations, where the issuer agrees to make donations to a particular organization based upon the usage of the card by the cardholder. In those cases, the cardholder commits to hold a card that benefits one particular group, the issuer incurs an expense and obtains a tax deduction when it contributes to the foundation, and the card holder makes no direct contribution to the entity and receives no tax deduction.

Another system for charitable donations involves charitable institutions raising money with merchants by selling the equivalent of gift certificates or pre-paid script from a particular merchant, and selling the script or gift certificate to customers. The customers then spend the script at the merchant, and the charity receives a portion of the funds.

What is needed is an efficient and customizable system whereby all participants to charitable donation-type transactions, for example, the credit card issuer, the credit card user and the charitable organization, each benefit from the transaction with minimal administrative costs. In addition, such a system may be attractive to the each of the participants, for example, a desirable feature for the credit card holder may be the ability and option to select the charitable organization that is to receive the donation. Finally, what is needed is system and method that easily associates charitable donation with business transactions.

### SUMMARY OF THE INVENTION

The present invention relates to systems and methods for facilitating the association of charitable donations with business and financial transactions. In a general embodiment, the present invention involves a credit or charge card that is either (a) tied to a particular charitable organization, school or foundation, or (b) a card that is simply designed towards charitable giving, where at different times the card holder can designate any one or more charitable organizations, schools, foundations or donor recipients.

In most scenarios where a charitable donation is tied to the use of a credit/charge card, the credit card issuer enters into an agreement with the cardholder that it will provide a percentage rebate to the cardholder based upon usage. The typical stipulation in such a scenario is that the credit card issuer will continue to provide rebates only if the card holder agrees to and does make a donation of the rebate to a tax-exempt particular charitable organization, school or foundation. Under current law, the credit card rebate is not income to the card holder. Once the rebate becomes the property of the card holder, the card holder donates the rebated funds to a designated charitable organization, school or foundation.

Implementations of a method for associating a charitable donation with a business transaction may optionally include, providing a certificate associated with at least one vendor to a customer, receiving notification of a business transaction using the certificate, and determining a charitable donation associated with the business transaction. In alternative embodiments, a method for associating a charitable donation with a business transaction includes generating certificates associated with a vendor. The certificates have a face value usable in exchanges with the vendor. The method also includes determining a charitable donation associated with the sale of each certificate based at least in part on either the face value of the certificate sold or the price of the certificate sold. Implementations of a system for associating a charitable donation with a business transaction include an intermediary providing certificates to customers. Each of the certificates is associated with a product or service provided by at least one vendor. The vendor or vendors receive certificates from the customer and provide notification to the intermediary of business transactions using the certificates. The intermediary determines a charitable donation associated with each of the business transactions.

Various implementations may include one or more of the following features. Certificates may be in the form of magnetically encoded credit, charge or debit cards, and may be marked with indicia associated with a charitable organization receiving the charitable donation. A balance associated with a certificate may be adjusted when a transaction is made. Transaction information associated with the discounted transactions may be stored in a database, which may in turn be made accessible using a website.

In addition to those features, various implementations of these methods may include purchasing advertising space and selling at least a portion of the advertising space to a vendor in exchange for certificates. Such methods may also include receiving compensation from the customers for the certificates and allocating a portion of the received compensation to the charitable organization. A portion of the received compensation may also be allocated to the vendor.

Using particular implementations of the invention, providers of goods and services can acquire new customers, and retain existing ones, via advertising that includes the branding of one or more charitable organizations. Likewise, charitable organizations can take advantage of the technological advances offered through the methods of the present invention, efficiently increasing their fundraising without the need to invest their financial resources in information technology and its infrastructure. Finally, consumers of goods and services can purchase items and utilize services they otherwise already consume, and obtain an added value to the transaction because part of the transaction amount is designated for charity. That the consumer can designate just which charity receives benefit from the purchase of goods and services by that consumer is an additional feature of certain implementations of the present invention.

In an alternative embodiment, the present invention enables donors to make charitable donations without using certificates, scripts or any pre-paid system, or placing a credit card with the customer. Under this system, the charitable organization places a card or other instrument with a person, the card can be scanned to determine what the person purchased and with which merchant. The card is either (a) tied to a particular charitable organization, school or foundation, or (b) is simply designed towards charitable giving, where at different times the card holder can designate any one or more charitable organizations, schools or foundations.

The charitable organization or company in charge of issuing the card, then enters into agreements with retailers, service providers, other merchants, or manufacturers of products to provide a rebate based upon purchases from the retailers, service providers, other merchants, or based upon purchases of specific products. The rebates are either (1) sent directly to the charitable organizations, or (2) to the holder of the card.

In the situation where the holder of the card receives the rebate, the issuer of the card enters into an agreement with the holder of the card that he or she agrees to and does make a donation of the rebate to a tax-exempt particular charitable organization, school or foundation. Under this scenario, the card holder receives a tax deduction for the contribution. The company issuing the rebate will have an expense, and therefore a tax deduction, for the rebate.

In alternative embodiments, the card issuer may also provide the service of directly providing, at the direction of the card holder, the rebates to the charitable organization. In further embodiments, the cardholder can easily maintain control over the destination of his or her donations by selecting the charity or charities of his or her choice from time to time or as necessary.

An advantage of the methods and systems described herein is that from a marketing perspective, the tax-exempt organizations can assist in marketing the cards to potential customers. Also, tax exempt organizations with limited life, such as one supporting a memorial or needing to raise funds on a one time basis, can then enter into agreements with issuer banks, without having to prove that they will attract many cardholders for a long time.

Another advantage of the present method is that for the tax-exempt organization, the card is a fund raising device where it does not have to ask individuals to come out of pocket to contribute to the organization. For the customer, it is a way to support the tax-exempt organization while obtain a taxable deduction.

Once the system is established, the card issuer can approach various merchants or manufacturers to increase rebates for specific tax-exempt organizations, or for all tax-exempt organizations affiliated with the card. The merchants can obtain additional business and enhance their reputation by allowing incentive rebates. Merchants can target specific markets for the first time using this system. For example, a retailer could focus upon a local university, or a local high school or elementary school, and other focused target markets, all using the same card, thereby earning loyalty from customers.

In another embodiment of the present invention, the credit card issuer can offer the card to employees of merchants or manufacturers who agree to provide incentive rebates. The merchant or manufacturer would then offer a benefit to their employees, while supporting tax-exempt organizations.

The details of one or more embodiments of the invention are set forth in the description and claims provided herein. Other features, objects, and advantages of the invention will be apparent from the description and claims.

### DETAILED DESCRIPTION OF THE INVENTION

The present invention may be understood more readily by reference to the following detailed description of specific embodiments included herein. Although the present invention has been described with reference to specific details of certain embodiments thereof, it is not intended that such details should be regarded as limitations upon the scope of the invention. The entire text of the references mentioned herein are hereby incorporated by reference in their entireties.

Charitable organizations may include any individual or organization that collects donations for any purpose, which may include, but are not limited to, traditional charities as well as other non-profit organizations. A vendor is any individual or organization providing any type of good or service for purchase by consumers or customers. The system also includes advertisers that provide information to customers about vendors to entice customers to purchase goods and/or services from particular vendors. Advertisers may include any organization that provides such information to customers using any appropriate medium of communication, including such forms as print media, broadcast media, in-person solicitation, and telemarketing. The system may also include an intermediary. An intermediary is an organization that facilitates donations from customers to charitable organizations by providing certificates to customers. Certificates are any medium of exchange accepted by one or more vendors such that the value of each certificate in exchange for goods and/or services is greater than or equal to the purchase price of the certificate. For example, one type of certificate with an exchange value of $100 when used at a particular vendor could be purchased for $70 or some other amount less than $100. Certificates may take any tangible or intangible form, including paper certificates, magnetically encoded cards, debit accounts, credit cards, or any other similar method of accounting for exchanges. In other implementations, charitable organizations may provide certificates to customers directly without using an intermediary, so it should be understood that the system and techniques described below may be suitably adapted to function without an intermediary.

Another embodiment of the present invention involves the charity obtaining donations without using certificates, scripts or any pre-paid system, or placing a credit card with the customer. Under this system, the charitable organization places a card or other instrument with a person, the card can be scanned to determine what the person purchased and with which merchant. The card is either (a) tied to a particular charitable organization, school or foundation, or (b) is simply designed towards charitable giving, where at different times the card holder can designate any one or more charitable organizations, schools or foundations.

The charitable organization or company in charge of issuing the card, then enters into agreements with retailers, service providers, other merchants, or manufacturers of products to provide a rebate based upon purchases from the retailers, service providers, other merchants, or based upon purchases of specific products. The rebates are either (1) sent directly to the charitable organizations, or (2) to the holder of the card.

In the situation where the holder of the card receives the rebate, the issuer of the card enters into an agreement with the holder of the card that he or she agrees to and does make a donation of the rebate to a tax-exempt particular charitable organization, school or foundation. Under this scenario, the card holder receives a tax deduction for the contribution. The company issuing the rebate will have an expense, and therefore a tax deduction, for the rebate.

The card issuer may also provide the service of directly providing, at the direction of the card holder, the rebates to the charitable organization.

From a marketing perspective, the tax-exempt organizations can assist in marketing the cards to potential customers. Also, tax exempt organizations with limited life, such as one supporting a memorial or needing to raise funds on a one time basis, can then enter into agreements with issuer banks, without having to prove that they will attract many cardholders for a long time. In another embodiment of the present invention, the cardholder can keep the card and convert the charitable donation associated with the card to another charity.

For the tax-exempt organization, the card is a fund raising device where it does not have to ask individuals to come out of pocket to contribute to the organization. For the customer, it is a way to support the tax-exempt organization while obtaining a taxable deduction.

Once the system is established, the card issuer can approach various merchants or manufacturers to increase rebates for specific tax-exempt organizations, or for all tax-exempt organizations affiliated with the card. The merchants can obtain additional business and enhance their reputation by allowing incentive rebates. Merchants can target specific markets for the first time using this system. For example, a retailer could focus upon a local university, or a local high school or elementary school, and other focused target markets, all using the same card. Retailers could earn customer loyalty from customers.

In another embodiment of the present invention, the credit card issuer can offer the card to employees of merchants or manufacturers who agree to provide incentive rebates. The merchant or manufacturer would then offer a benefit to their employees, while supporting tax-exempt organizations.

Overall, the system allows a donation to one or more of the charitable organizations to be associated with a business transaction between customers and vendors. This provides incentives for customers to engage in transactions with vendors. Furthermore, the association of charitable organizations with the transactions not only provides customers wishing to support a charity with additional incentives to engage in such transactions, but also provides a relatively easy way for charitable organizations to receive donations from customers. The use of various marketing strategies leveraging the logos, marks, or other branding indicia of charitable organizations in conjunction with similar indicia of vendors may also provide additional ways to utilize the association between vendors and charitable organizations. A provider of goods and/or services may increase the sales of such goods and/or services by offering its goods and/or services in connection with the brands of charitable organizations. The use of such brands, coupled with the general desire by potential consumers to contribute to charities, and designate the recipient charitable organization associated with the transaction, works to produce increased sales.

The following is one example of a business or financial transaction associated with charitable donations. In one embodiment of the system of the present invention, the credit card issuer enters into an agreement with the cardholder that it will provide a percentage rebate to the cardholder based upon usage. The credit card issuer will continue to provide rebates only if the card holder agrees to and does make a donation of the rebate to a particular tax-exempt charitable organization, school or foundation. The credit card rebate is not income to the card holder. However, once the rebate becomes the property of the card holder, the card holder donates the rebated funds to the particular charitable organization, school or foundation. The cardholder then receives a tax deduction for the contribution. The credit card issuer has an expense from providing the rebate, and is allowed to claim a tax deduction for the rebate.

Organizations that will attract few cardholders can now enter into agreements with larger issuers, because the issuer need not start a new card for one charity; but can instead issue a card devoted to contributing, where the customers can be part of a larger pool or be transferred to other organizations using the same card. The expected term that the cardholder will hold the card can be increased by (a) affiliating with a

The goal of the new system for the issuer (a) to reduce the cost of obtaining customers for credit card issuers, (b) to increase the expected time that a card holder retains and uses the credit card. For the tax-exempt organization, the card is a fund raising device where it does not have to ask individuals to come out of pocket to contribute to the organization. For the customer, it is a way to support the tax-exempt organization while obtaining a tax deduction for charitable contributions.

Once the system is established, the card issuer can approach various merchants or manufacturers to increase rebates for specific tax-exempt organizations, or for all tax-exempt organizations affiliated with the card. The merchants can obtain additional business and enhance their reputation by allowing incentive rebates. Merchants can target specific markets for the first time using this system. For example, a retailer could focus upon a local university, or a local high school or elementary school, and other focused target markets, all using the same credit card. Retailers could earn customer loyalty from customers.

In another embodiment of the present invention, the credit card issuer can offer the card to employees of merchants or manufacturers who agree to provide incentive rebates. The merchant or manufacturer would then offer a benefit to their employees, while supporting tax-exempt organizations.

In another example, an intermediary manages an exchange of certificates between vendors and customers. Vendors provide certificates to an intermediary, which are sold by an intermediary to customers. In exchange for the certificates received from vendors, the intermediary coordinates an advertising campaign in which vendor brands are advertised in conjunction with shared brands provided by charitable organizations. As part of the advertising campaign, both advertisers and the intermediary may provide co-branded advertisements to customers. The co-branded advertisements inform customers that certificates for vendors are available for purchase and that a portion of the proceeds from the sale of certificates will be donated to charitable organizations. Customers, attracted by the prospect of receiving goods and services while donating to charities, purchase certificates from the intermediary. The payments from customers are used in part to fund donations to charitable organizations that made shared brands available, so that donations are associated with providing goods and services to customers. Each customer purchasing certificates may be allowed to designate which of the charitable organizations will receive donations associated with his or her purchase. Customers then use the certificates to obtain goods or services from vendors. The certificates may be delivered in a customized format to increase attractiveness and/or expedience. For example, certificates may be customized with the logo of charitable organization and/or vendor. Certificates may be incorporated into gift packs that provide information such as the recipient's name, the giver's name, the logo of one or more participating vendors and/or charitable organizations to whom donations will be made, a personalized message, or numerous other customized messages. Certificates may also be provided in the form of a magnetically encoded card, allowing transactions to be electronically processed to facilitate use at vendor premises and providing a single easy-to-carry form for multiple certificates. Such cards may also be made rechargeable, such as by associating the cards with a customer account, which provides added convenience for future certificate purchases. To prevent fraud, certificates may be associated with a unique identifier, such as a bar code or magnetically coded number. This allows certificates to be cancelled if used, lost, or stolen.

The described methods for associating a business or financial transaction with a donation to a charitable organization may be applied to any manner of business involving the exchange or sale of goods and/or services. Some examples of such businesses include retail stores, restaurants, travel agencies, including sales of vacation packages and similar travel consolidation services, and telecom vendors, including prepaid telephone cards as well as incentive programs for switching to a telecom provider. In principle, however, there is no limit to the types of business to which the methods may be applied.

Any of the aforementioned types of certificates may be used in conjunction with the method of the invention. For example, a type of certificate that may be used for such an implementation is a debit card that draws on a prepaid account. Essentially, this provides the purchaser with a balance that can be used just like an ordinary debit card, but with the advantage that using the card at participating vendors triggers both the discount and the associated charitable donation. The debit card permits application of a relatively tiny percentage of transactions. To provide additional incentives for using the debit card, refilling the card may be billed to a credit card as a purchase from an intermediary. The result is that the purchaser may use another credit card to refill the prepaid balance to realize benefits associated with buying products with the credit card, such as cash-back bonuses, reward points, or frequent flyer miles. Thus, the purchaser is able to capture the rewards of both the system with the associated charitable donation and the credit card rewards program. Another embodiment of the system is to process and monitor the use of certificates in the form of debit cards. In an example of this function, the customer presents a debit card at retail store. A store employee swipes the debit card in card reader, which communicates with a computer system of credit card company to verify that funds are available. The computer system may in turn communicate with a central computer system to confirm that there are sufficient funds in the customer account to cover the transaction. If sufficient funds are available, the computer system debits the account, verifies the transaction to the store employee, and records the transaction. Later, the central computer system may retrieve this information from credit card computer system to update a database with the recent transaction information. This information in turn may be used to track the requisite donations to charitable organizations. The system manages and records transactions. The system may also make this information available to vendors, customers, and charitable organizations, allowing them to monitor the effectiveness of the system to positively identify the benefits realized. One method of making such information accessible is through the use of a secure, password-protected website, although any of numerous methods of accessing the system, such as touch-tone telephone access or email requests, may be employed. In an example of website access, a customer may access the system from the customer's residence. In addition to allowing services such as purchasing and refilling certificates, the website may allow customers to track their total charitable contributions, which is useful for capturing tax benefits, change the charitable organizations that are receiving donations from transactions, and perform numerous other services related to the management of a customer account. The system may also use techniques such as email notification to make customers aware both of the savings they have received and the donations they have made.

In addition, the system provides access to vendors and charitable organizations regarding business and financial transactions. For example, the system may track the number of transactions for vendors, the number of purchased certificates, the amount of usage of click-through ads on the intermediary's website, and any other information useful for vendor. For charitable organizations, the system may provide information on total accumulated contributions as well as patterns of usage, such as identifying particular vendors that donors to a particular charitable organization frequent. In such transactions, it may be desirable or necessary to protect customers private or personally identifiable information, so that customers do not have negative experiences with the system due to undesirable solicitation by vendors or charitable organizations.

Although a particular example or method has been described, it should be understood that there are numerous other methods for associating charitable donations with business or financial transactions. In particular, any method consistent with any of the implementations described above may be used. Furthermore, various steps of the method may be performed in a different order, particular steps of the method may be omitted, and additional steps may be included in a manner consistent with any of the implementations described herein.

Advantages of particular implementations are numerous and varied. One advantage of some implementations is that the techniques for associating charitable donations with business or financial transactions are scalable. Such implementations may be extended to more vendors, charitable organizations, and transactions without substantially altering the method of operation. Another advantage of particular implementations is allowing a charitable organization to efficiently increase its fundraising without increasing its overhead. Such an advantage may be realized by making it easier for individuals to contribute to charitable organization of their selection by engaging in activities that are already part of a customer's ordinary routine. Additional benefits may be realized by enabling the charitable organization to use the technological infrastructure of an intermediary to reach new potential donors, and retain existing ones, without having to invest in information technology or similar infrastructure. Intermediaries may also realize advantages associated with particular implementations. For example, an intermediary may be able to make a profit without carrying an inventory of products or undertaking any overhead associated with the traditional offering of goods and/or services. Particular implementations may afford some, none, or all of the enumerated advantages.

Various modifications and variations to the described embodiments of the inventions will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the art are intended to be covered by the present invention.

What is claimed is:

1. A method for associating a charitable donation with a business or financial transaction, wherein the business or financial transaction comprises the use of a credit card and wherein the transaction further comprises:
a credit card issuer entering into an agreement with the cardholder that it will provide a percentage rebate to the cardholder based upon usage;
wherein the percentage rebate is provided directly to the cardholder and wherein the cardholder may select the recipient of the charitable donation.

2. The method of claim 1, wherein the recipient of the charitable donation has a business affiliation with the credit card issuer so that transfer of funds can be automated and facilitated.

3. The method of claim 1, wherein the recipient of the charitable donation is a tax-exempt organization.

4. The method of claim 3, wherein the tax-exempt organization comprises a charitable organization, school, memorial fund, disaster-relief fund, humanitarian fund, or individual.

5. The method of claim 1, wherein the recipient of the charitable donation does not have business affiliation with the credit card issuer and the transfer of funds is specifically directly by the credit card holder.

6. The method of claim 1, wherein the credit card issuer is associated with business entities such as retailers and merchants, wherein said business entities further contribute to the percentage rebate to the cardholder based upon usage.

7. The method of claim 6, wherein the recipient of the charitable donation has a business affiliation with the credit card issuer so that transfer of funds can be automated and facilitated.

8. A method for associating a charitable donation with a business or financial transaction, wherein the business or financial transaction comprises the issuance of a certificate and wherein the transaction further comprises:
a certificate issuer entering into an agreement with the certificate holder that it will provide a percentage rebate to the certificate holder based upon usage;
wherein the percentage rebate is provided directly to the certificate holder and wherein the certificate holder may select the recipient of the charitable donation.

9. A method for associating a charitable donation with a business or financial transaction, wherein the business or financial transaction comprises the use of a credit card and wherein the transaction further comprises:
a credit card issuer entering into an agreement with the cardholder that it will provide a percentage rebate to the cardholder based upon usage;
wherein the percentage rebate is provided directly to the cardholder thereby enabling the cardholder to qualify for a tax deduction and wherein the cardholder may select the recipient of the charitable donation.
